(19) United States
(12) Patent Application Publication
(10) Pub. No.: US 2026/0312826 A1
(43) Pub. Date: Oct. 8, 2026

(54) DIGITAL CERTIFICATE-BASED AUTHENTICATION OF CONFIGURATION CHANGES IN INDUSTRIAL DEVICES

(71) Applicant: Schneider Electric Systems USA, Inc., Foxborough, MA (US)

(72) Inventors: James REDMOND, Richmond (CA); Pamela COLQUHOUN, Dunrobin (CA)

(21) Appl. No.: 19/171,966

(22) Filed: Apr. 7, 2025

(51) Int. Cl. H04L 9/32; H04L 9/08

(52) U.S. Cl. CPC H04L 9/3268; H04L 9/0825; H04L 9/3247

(57) ABSTRACT

An industrial device and industrial automation system for securing device configurations stored in memory through digital certificate-based authentication. The industrial device includes a processor and a security module for certificate-based authentication. Upon receiving a request to write a new configuration to the industrial device, the device requires a digital certificate from the entity attempting to make the configuration change. The certificate is evaluated to authenticate the user's identity and permissions. Evaluation involves decryption and validating the format, content, and validity period of the certificate. Only after successful authentication and permission verification is the new configuration written to memory and applied.

### FIELD

This disclosure generally pertains to methods and systems that employ digital certificates to authenticate configuration changes for industrial devices.

### BACKGROUND

Cybersecurity is a concern for operational technology in industrial automation systems. Industrial devices such as controllers, instruments, remote terminal units (RTUs), multivariable transmitters (MVTs), sensors and human-machine interfaces (HMIs) are vulnerable to cyber-attack. These devices have configurations that define various aspects of how the device operates to facilitate industrial automation. Conventionally, industrial device configurations are secured by basic authorization mechanisms such as password production, directory services, or physical layers. The increasing number of cybersecurity attacks and the vulnerability of industrial technology necessitates heightened security measures, such as those offered by digital certificates.

### SUMMARY

In one aspect, a method of securing a device configuration stored in memory associated with an industrial device comprises receiving a write request from a user to write a new device configuration to the industrial device. In response to the write request, a certificate from the user is requested. The certificate contains an identity of the user and a digital signature. In response to receiving the certificate, the certificate is evaluated to authenticate the user and determine the user has permission to write device configurations to the industrial device. After determining that the user has permission, the new device configuration is written to the memory and the industrial device is operated in accordance with the new device configuration.

In another aspect, an industrial device comprises a processor and a memory storing processor-executable instructions including a device configuration and a device configuration security module. The device configuration configures the processor to operate in the industrial automation system in accordance with specified device capabilities. The device configuration security module configures the processor to conduct a certificate-based authentication routine in response to receiving a request to write a new device configuration to the memory from the user.

In another aspect, an industrial automation system comprises a plurality of industrial devices configured to operate the industrial automation system. A computing device is in communication with one of the industrial devices. The computing device includes a memory storing a new device configuration for said one of the industrial devices and a certificate authenticating user authorization to change the configuration of the industrial device. Said one of the industrial devices is configured to receive a request from the computing device to write the new device configuration to said one of the industrial devices, and in response, to conduct a certificate-based authentication routine by which said industrial device requests the digital certificate and evaluates the certificate to validate the certificate as acceptable and provide user authorization to change the configuration of the industrial device, before said one of the industrial devices applies the new device configuration in the industrial automation system.

Other aspects will be in part apparent and in part pointed out hereinafter.

### BRIEF DESCRIPTION OF THE DRAWINGS

FIG. 1 is a schematic block diagram of a system for digital certificate-based authentication of configuration changes in industrial devices.

FIG. 2 is a schematic block diagram of an example industrial automation system in which the system for digital certificate-based authentication can be employed.

FIG. 3 is a flow chart illustrating a method of securing a device configuration of an industrial device using digital certificates.

FIG. 4 is a flow chart of a sub-process of FIG. 3.

Corresponding parts are given corresponding reference characters throughout the drawings.

### DETAILED DESCRIPTION

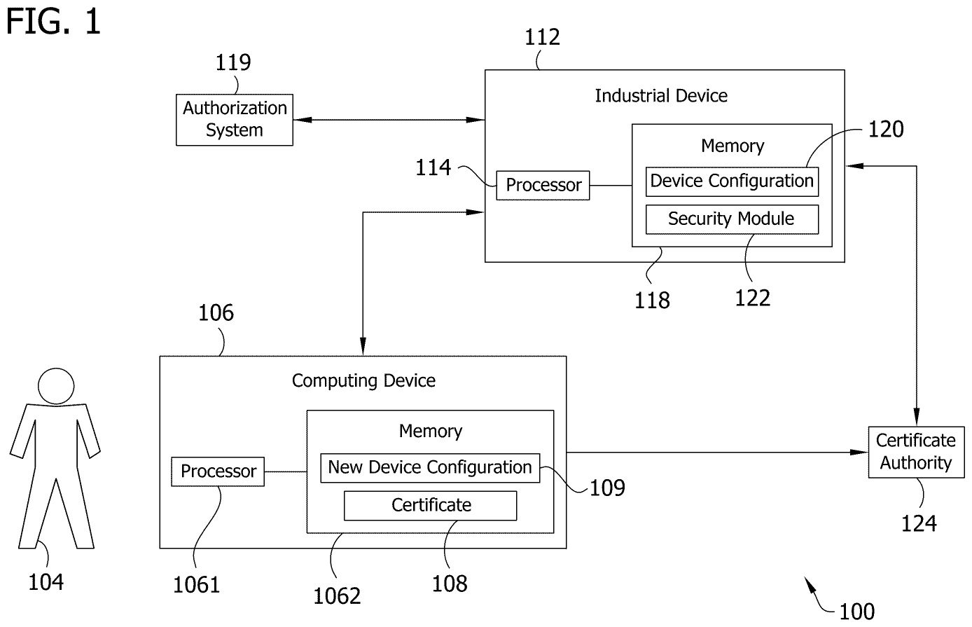

FIG. 1 is a schematic overview of a system 100 for digital certificate-based authentication of configuration changes for industrial devices 112 used in industrial automation systems. As will be explained in further detail below, this disclosure pertains to various types of industrial devices used in industrial automation systems, including but not limited to, programmable logic controllers (PLCs), remote terminal units (RTUs), distributed control system (DCS) controllers, transmitters (e.g., pressure transmitters, temperature transmitters, flow transmitters, multivariable transmitters (MVTs), etc.), and sensors. As will be known to those skilled in the art, these types of industrial devices are programmed with reconfigurable device configurations that defines certain device capabilities that dictate how the industrial device will function in the industrial automation system.

For example, in the case of a PLC, the device configuration could define logic programming, input/output (I/O) configuration, communication protocols, timing, sequencing, alarm settings, diagnostic settings, etc. In the example of an RTU, the device configuration could define communication configuration, I/O point configuration, data logging and storage configurations, local control logic, etc. In the case of a DCS controller, the device configuration can define control algorithms, process variables, human machine interface integration settings, redundancy settings, batch processing rules, etc. For transmitters, the device configuration can define measurement range, units of measure, output signal configuration, communication protocol, diagnostic routines, calibration values, zero/span settings, damping and filtering parameters, alarm settings, etc. In the case of applicable industrial sensors, the device configuration can define the measurement range, sensitivity, output signal configuration, communication protocol, diagnostic routines, calibration values, self-monitoring logic, damping parameters, filtering parameters, other signal processing rules, alarm settings, etc.

Those skilled in the art will appreciate that device configurations directly affect the functioning of industrial automation systems, including industrial automation systems that run critical infrastructure and industrial processes that can present significant safety risks if operated improperly. Accordingly, there is a need to ensure that changes to device configurations are only made by those with the proper knowledge, training, and experience. In other words, there is a need to secure industrial devices 112 against unauthorized device configuration changes.

According to the principles of at least some embodiments described in the present disclosure, industrial device configurations are secured by using digital certificates to authenticate users attempting to make a configuration change. A digital certificate is an electronic “ID card” that verifies the identity of a user. Digital certificates are widely used in information technology (IT) contexts to authenticate users by cryptographically linking their identity to a public key, allowing secure verification within a network. Digital certificates can be self-signed, meaning they are issued and signed by the same entity that owns the certificate, or obtained through a trusted third-party certificate authority such as DigiCert, Entrust, GlobalSign, GoDaddy or Sectigo. As explained above, industrial devices are apparatuses employed in operational technology (OT) applications, such as industrial process control, robot automation, oil and gas, and municipal services. As discussed in connection with at least some embodiments, digital certificates can be adapted from their IT origins to OT systems to secure the device configurations of industrial devices. Further, at least some embodiments herein demonstrate that using digital certificates to secure device configurations can enhance the security of the industrial devices in relation to conventional security mechanisms used in OT environments.

FIG. 1 depicts a user 104 using a computing device 106 (e.g., personal computer, smartphone, tablet, touchscreen HMI device). In some embodiments, the user 104 may correspond to any entity in operable communication with a computing device 106, such as another computing system (not shown) that is attempting to change the configuration of industrial device 112. In the embodiment of FIG. 1, the user 104 is an individual attempting to change the configuration of an industrial device 112. FIG. 1 further depicts an optional certificate authority 124. The certificate authority 124 is broadly configured for issuing certificates that identify users in the OT system where the industrial device 112 operates (e.g., an industrial automation system, as described in further detail below). The illustrated computing device 106 is communicatively connected to the certificate authority 124 and the industrial device 112. Suitable communication connections can be established locally or remotely, e.g., via a communications network, such as a private data radio network, a cellular telephone network, or other long-range communication network.

In this disclosure, the computing device 106 can function as the device from which the user 104 attempts to make a change to the device configuration 120 of one or more industrial devices 112. The computing device 106 suitably comprises a processor 1061 and a memory 1062 storing processor-executable instructions that, when executed by the processor, configure the processor to perform certain functions. Among other functions, the illustrated computing device 106 can be configured to (i) interact with a certificate authority 124 to obtain a digital certificate 108, (ii) generate a self-signed digital certificate 108, and/or (iii) interact with an industrial device 112 to write a new device configuration 109 to the industrial device. Hence, FIG. 1 depicts the memory 1062 storing a new device configuration 109 and a digital certificate 108 that acts as the ID card for the user 104 within the OT system in which the industrial device 112 is deployed.

In one embodiment, the digital certificate 108 is a self-signed digital certificate. A self-signed certificate is created by generating a public-private key pair and then using the private key to sign the certificate. In the self-signed certificate embodiment, the OT organization (e.g., the entity controlling the industrial automation system, such as an operator of the industrial automation system) assumes responsibility for managing the trust of its certificates, including securely storing the private keys and ensuring that certificates are renewed as needed. The process for creating a self-signed certificate involves creating a certificate signing request and then using the private key to sign that request. Tools like OpenSSL or platform-specific tools are used to facilitate the creation of self-signed certificates. A self-signed certificate will contain the identity of the certificate holder, the certificate's public key, a validity period indicating the dates on which the certificate is valid, and a digital signature, which is a hash of the certificate's data encrypted by the certificate's private key. The OT organization may also include in the self-signed certificate custom fields that grant the certificate holder certain permissions within the OT network. Most pertinent to this disclosure, the certificate can include a field that grants or denies the certificate holder permission to make configuration changes to one or more industrial devices 112 in the OT network.

In another embodiment, the user 104 obtains the digital certificate 108 from a certificate authority 124. The certificate authority 124 verifies the user's identity and, if approved, creates the digital certificate 108 for the user. Most certificate authorities 124 use the X.509 standard for their digital certificates. In accordance with the X.509 standard, the digital certificate 108 contains several elements including the issuer, the identity of the certificate holder, a public key, a digital signature, and a validity period or date range for when the certificate is deemed valid. Again, the OT organization can further define custom extensions to the certificate, such as one or more fields that grant or deny the certificate holder permission to make configuration changes on an industrial device 112. The certificate authority 124 uses its private key to create a digital signature on the certificate 108, which encrypts a hash of the certificate's data, ensuring its integrity and authenticity. The certificate authority 124 may be a root certificate authority, or more likely, a subordinate certificate authority, e.g., a subordinate certificate authority that is managed by the OT enterprise.

As mentioned above, in one or more embodiments, the digital certificate 108 can contain custom extensions that grant the certificate holders certain permissions (e.g., authorization to write new device configurations on one or more industrial devices 112) within the OT network. In another embodiment, the digital certificate 108 does not have custom extensions. Instead, the digital certificate 108 can be a standard-form certificate that authenticates the identity of the certificate holder. In these embodiments, the system 100 further comprises a separate authorization system 119. The authorization system 119 comprises a role-based directory that is accessible to one or more industrial devices 112 in the OT network. After being presented with a digital certificate 108 that establishes the identity of the user 104 attempting to make a configuration change (the process for this will be described in further detail below), the industrial device 112 can interact with the authorization system 119 to verify that the certificate-verified user has the necessary permissions to write the new device configuration 109 to the industrial device.

In some cases, the certificate authority 124 or the OT organization (e.g., via the authorization system 119 can maintain one or more lists indicative of certificate status, such as a revocation list and/or an “allowlist” (sometimes referred to in the art as “whitelist” but which will be referred to herein as “allowlist”) of digital certificates. A revocation list is also sometimes called a certificate revocation list. It contains certificates that have been revoked before the expiration date stated on the certificate, indicating they are no longer valid. Revocation lists are used when a certificate is compromised or a user 104 (certificate holder) leaves the OT organization. An allowlist has the opposite function. It identifies certificates that are explicitly trusted by the organization. Revocation lists and/or allowlists can be used in at least some embodiments of the security applications in the scope of this disclosure, to help the OT organization manage the certificates after they are issued.

Referring still to FIG. 1, the industrial device 112 is shown schematically to indicate the general elements in common among the various types of industrial devices that are within the scope of the present disclosure. The industrial device 112 broadly comprises a processor 114 and a memory 118. The memory 118 stores processor executable instructions that, when executed by the processor 114, configure the processor to perform certain functions. Among other processor-executable instructions, the memory 118 stores a device configuration 120 that configures the processor 114 to execute certain device capabilities in the industrial automation system. Additionally, the memory 118 stores a device configuration security module 122 that configures the processor 114 to conduct a certificate-based authentication routine in response to receiving a request to write a new device configuration to the memory 120 from the user 104. The certificate-based authentication routine causes the industrial device 112 to request the user's digital certificate 108 and authenticate the user's identity and permissions before writing a new device configuration 109 from the computing device 106 to memory 118.

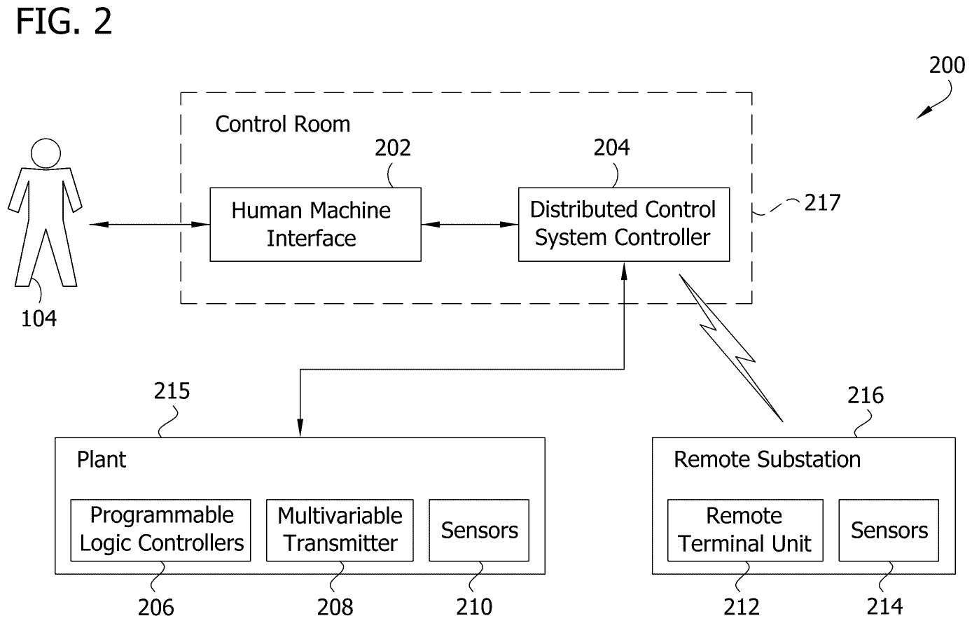

The certificate-based authentication system 100 depicted in FIG. 1 can be used to secure the device configuration of any type of industrial device or, more broadly, the device configuration of any type of OT device without departing from the scope of the disclosure. FIG. 2 schematically illustrates an industrial automation system 200 that provides a representative example of an OT system 200 in which the certificate-based authentication system 100 may be employed. The industrial automation system 200 includes a distributed control system (DCS) controller 204 communicating with one or more industrial devices in a plant 215 and/or one or more remote substations 216. The aspects of this disclosure pertaining to digital certificate authentication may be applied to various industrial devices, including any of the industrial devices depicted in FIG. 2, for example, a programmable logic controller (PLC) 206, a remote terminal unit (RTU) 212, a DCS controller 204, a multivariable transmitter (MVT) 208, sensors 210, and a human-machine interface (HMI) 116.

The DCS controller 204 of FIG. 2 is coupled to a remote substation 216 via a communications network, such as a private data radio network and/or a cellular telephone network. The substation 216 typically includes a number of sensors 210 and at least one RTU 212 for data acquisition from substation 216 and/or from the DCS controller 204. The RTU 212 transmits telemetry data to the DCS controller 204 and receives messages back for controlling connected physical objects of the remote substation 216.

As shown in FIG. 2, the DCS controller 204 operates in conjunction with a human-machine interface (HMI) 116. The HMI 202 is an input-output device that presents process information to a human operator, referred to as the user 104. The DCS controller 204 links to HMI 202 for providing maintenance procedures, detailed schematics, logistic information, trend data, diagnostic data, and the like for a specific sensor or machine. Although illustrated in a control room 217 remotely from the various industrial devices, it is to be understood that HMI 202 could be hosted on the industrial device 112 itself. In one or more embodiments, the user 104 uses the HMI as the computing device 106 to make a request to write a new device configuration to any of the industrial devices 202, 204, 206, 208, 210, 212.

In addition to the RTU 212, sensors 210, and other components of remote substation 216, the DCS controller 204 communicates with at least one PLC 206 for a plant 215. In the plant 215, PLC 206 is connected to, for example, a sensor 210 for collecting the sensor output signals and converting the signals into digital data. The DCS controller 204 may also communicate with a transmitter, such as MVT 208, which is used to measure flow, differential pressure, temperature, pressure, and the like.

As described above, cybersecurity is a key concern for operational technology in critical infrastructure such as pipelines, water/wastewater, electricity, etc. The failure to secure access could be used to compromise the operational integrity of an industrial device 112, such as RTU 212, PLC 206, MVT 208, sensor 210, or the like, which may be operating to control a critical infrastructure device. Aspects of the present disclosure use digital certificates for user authentication to change the device configuration of one or more of these industrial devices 202, 204, 206, 208, 210, 212. A digital certificate authentication system 100 according to aspects of the present disclosure facilitates the centralized management of credentials in operational technology to ensure user privileges are restricted to active, valid users who have permissions to access to selected operations, including operational modes, configurations, features, data, etc. Digital certificates offer an enhanced mechanism to ensure the security and safety of operational technology. The cryptographic features of digital certificates drastically limit the ability of hackers to falsify them, providing strong user authentication by verifying the identity of those individuals accessing critical systems. The added layer of security, provided by digital certificates, makes remote industrial devices considerably more resilient against cyber-attacks, reinforcing the protection of critical infrastructure operations.

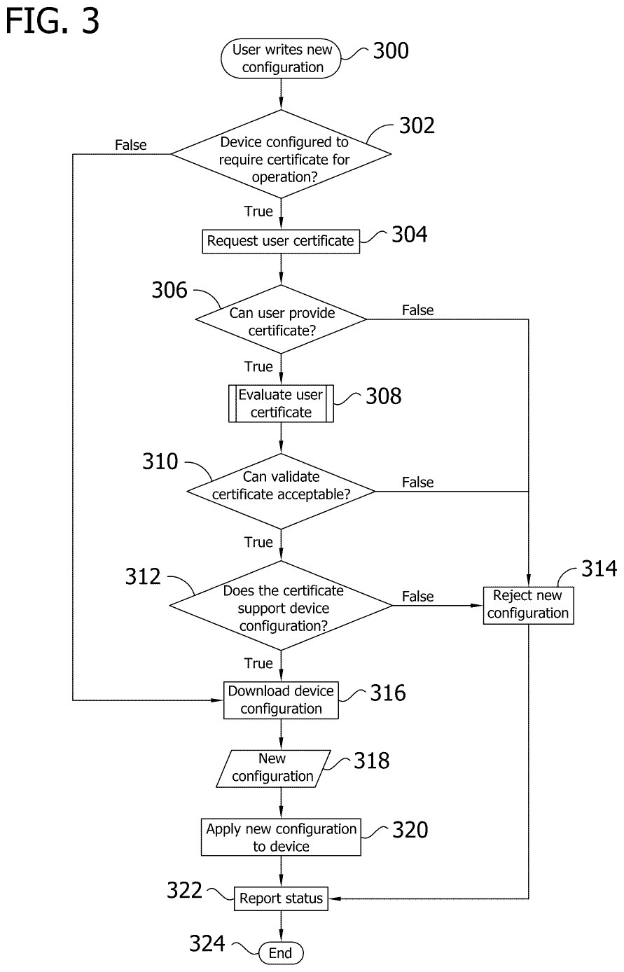

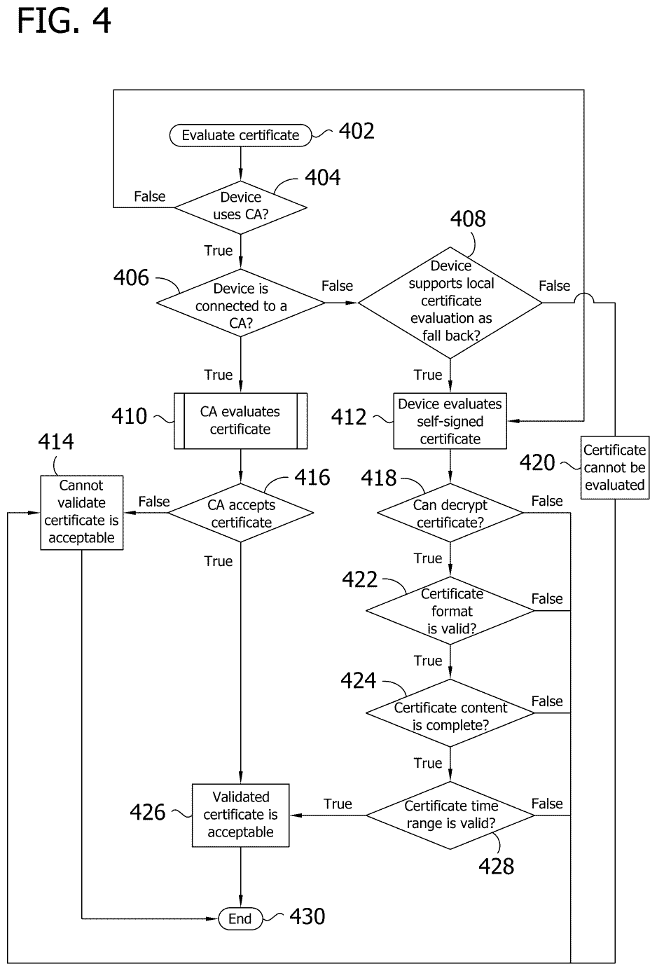

Referring now to FIGS. 3 and 4, an exemplary method of using the certificate-based authentication system 100 to secure one or more device configurations 120 in an industrial automation system 200 will now be described. The example method of FIG. 3 begins at 300, where the user 104 attempts to write a new configuration 109 to an industrial device 112. If the device 112 is not configured to require a certificate for operation (e.g., the device lacks the certificate-based security module 122 depicted in FIG. 1), as determined at 302, the industrial device downloads the new device configuration 109 at 316. If the industrial device 112 is configured to require a certificate for operation, as determined at 302, the security module 122 causes the device 112 to request the user's digital certificate 108 from the computing device 106 at 304 before downloading the new configuration 109. If the user cannot provide the certificate 108, as determined at 306, the security module 122 prompts the device 122 to reject the new configuration 109 at 314 and a report status is generated at 322. If the user can provide the certificate 108, as determined at 306, the security module 122 conducts a certificate evaluation subroutine step at 308, which is described in further detail in the discussion of FIG. 4 below. For example, the certificate evaluation subroutine 308 can involve verifying the certificate's digital signature (broadly, decrypting the certificate), confirming the certificate 108 adheres to a valid format (such as X.509), assessing the completeness of the certificate's contents to ensure it contains all necessary fields such as the issuer, identity of the certificate holder, public key, validity period and digital signature, and the reviewing the certificate's validity period to ensure the current time falls within its active date range. Upon completion of the certificate evaluation subroutine 308, at decision point 310, a final determination is made whether the certificate 108 is valid.

If the certificate 108 cannot be validated, as determined at 310, the new configuration is rejected at 314 and a report status is generated at 322.

If the certificate 108 is properly validated, at 312, a determination is made as to whether the certificate supports device configuration. Determining whether the certificate supports device configuration is accomplished by assessing user permissions, which can originate from several sources. In one instance, the digital certificate 108 has a custom, task-specific certificate type that is issued for the dedicated purpose of granting users 104 permission to make device configuration changes. In this scenario, decision point 312 involves no additional analysis. The user 104 is determined to have permission to write the new device configuration 109 to the industrial device memory 118 simply because the user has and is able to produce the custom, task-specific digital certificate 108.

In one or more embodiments, the necessary permissions can also be determined in decision point 312 from the content of the digital certificate 108. As explained above, in certain examples, the digital certificate 108 can be customized to include extensions that define user permissions, such as permissions that grant or deny the user authorization to write a new device configuration 109 to the industrial device 112. In this scenario, the industrial device 112 interrogates the certificate upon receipt to ensure that it has the necessary permission.

If the certificate 108 itself or its contents do not provide the necessary permissions in and of themselves, in another embodiment, the industrial device 112 is configured to query the authorization system 119 to determine if the certificate holder has the necessary permission to write the new configuration 109 to the industrial device. As explained above, the authorization system 119 maintains a directory of certificate holders and their permissions. The industrial device 112 requests confirmation for the authorization system 119 whether the certificate holder has permission to write a new configuration 109 to the memory 118 of the industrial device, and the authorization system 119 returns the answer.

If the certificate 108 does not support device configuration, as determined at 312, the new configuration is rejected at 314 and a report status is generated at 322. If the certificate supports device configuration, as determined at 312, the device configuration 109 is downloaded, at 316, 318, onto the memory 122 of the industrial device 112. The configuration change initiated by the user at 300 is thus applied to the device at 320, and a report status is generated at 322. After the new device configuration 109 is stored in the memory 118, the industrial device 112 proceeds to operate in accordance with the device capabilities defined by the new device configuration. The example process of FIG. 3 ends at 324.

FIG. 4 schematically illustrates the certificate evaluation subroutine 308 in greater detail, beginning at 402. At decision point 404, the industrial device, executing the security module 122, makes a determination whether to use a certificate authority 124 to evaluate the certificate 108 presented by the computing device 106. If the industrial device 112 does not use a certificate authority 124, as determined at 404, the certificate 108 is a self-signed certificate, and the process proceeds at 412 to perform self-evaluation of the certificate. If the device uses a certificate authority, as determined at 404, the process makes a determination at 406 as to whether the device 112 is connected to the certificate authority 124. If the device is not connected to the certificate authority 124, a determination is made as to whether the device supports local certificate evaluation at 408. If the device 112 supports local certificate evaluation, as determined at 408, the process proceeds at 412 to perform local evaluation of the certificate 108 (discussed below). If the device 112 does not support local certificate evaluation, as determined at 408, the certificate 108 cannot be evaluated at 420, and it cannot be validated at 414, which results in the write request for the new configuration being rejected (step 314 in FIG. 3) and a status report being generated (322).

If the industrial device 112 is connected to a certificate authority 124, as determined at 606, the device conveys the certificate 108 to the certificate authority, which in turn engages in a sub-process to evaluate the certificate at 410. If the certificate authority 124 does not accept the certificate 108, as determined at 416, the certificate cannot be validated at 414, which results in the write request for the new configuration being rejected (step 314 in FIG. 3) and a status report being generated (322). If the certificate authority 124 accepts the certificate 108, as determined at 416, a validated certificate is acceptable at 426. In addition to verifying the digital certificate's contents, the certificate authority 124 can check a revocation list and/or an allowlist to evaluate the certificate 108. If the digital certificate 108 is found on the revocation list, it is rejected at 416. If the digital certificate 108 is found on the allowlist, it is accepted at 416.

The process for evaluating a self-signed certificate begins at 412. The process makes four determinations at 418, 422, 424, and 428. If the outcome of any one of those four determinations is false, the certificate 108 cannot be validated as acceptable at 414, which results in the write request for the new configuration being rejected (step 314 in FIG. 3) and a status report being generated (322).

At 418, the evaluation process determines if the certificate 108 can be decrypted. For example, at 418, the industrial device 112 calculates a hash of the certificate's contents, uses the public key (which could be the public key of the certificate holder in the case of a self-signed certificate or the public key of a certificate authority in the case of a certificate authority-generated certificate sent to an industrial device that is not currently connected to the certificate authority in 406) to unwrap the signed hash, and then compares the calculated hash with the unwrapped signed hash to verify the match. If the two hash values match, the data within the digital certificate 108 has not been altered and user's identity is authenticated. Thus, if the self-signed certificate can be decrypted, as determined at 418, the process proceeds to the second determination.

At 422, the security module 122 determines if the self-signed certificate's format is valid. Valid format means the certificate 108 is in the correct/expected custom format or the correct standard format, such as X.509. If the certificate 108 is not in a valid format, it is not acceptable. If the self-signed certificate's format is valid, as determined at 422, the process proceeds to the third determination.

At 424, the security module 122 determines if the self-signed certificate's content is complete. The certificate 108 should contain all of the required fields, such as the issuer, identity of the certificate holder, public key, validity period, and digital signature. If the self-signed certificate's content is complete, as determined at 424, the process proceeds to the fourth determination.

At 428, the evaluation process determines if the self-signed certificate 108 contains a valid time range. Digital certificates can include “not valid before” and “not valid after” dates. These dates define the window of time during which the certificate is considered valid. The certificate 108 should not have expired or not yet been issued. If the certificate 108 is not within the valid time range, it is not acceptable. If the self-signed certificate's time range is valid, as determined at 428, the certificate is deemed acceptable at 426. The example process of FIG. 4 ends at 430.

Accordingly, it can be seen that this disclosure provides improved systems and methods for securing the device configuration of various industrial devices by using certificate-based authentication to verify the identities of users attempting to make configuration changes. While the principles of certificate-based authentication for device configuration changes have been described above in relation to one example industrial automation system 200 and its example industrial devices 202, 204, 206, 208, 210, it will be understood that this disclosure could be adapted to any number of industrial automation systems and industrial devices, e.g., motion control, robotics, control lobs, telemetry systems, remote SCADA systems, etc. Further, the principles of the present disclosure could be adapted to other types of OT devices with reconfigurable device configurations. For example, it is contemplated that the systems and methods for certificate-based authentication disclosed herein can be adapted for securing the device configurations of consumer devices (e.g., televisions, radios, appliances, headphones, thermostats), industrial communications devices (e.g., Ethernet routers, Ethernet switches, serial port multiplexers, USB hubs, copper to fiber converters, etc.), among others.

For purposes of illustration, programs and other executable program components may be shown as discrete blocks. It is recognized, however, that such programs and components reside at various times in different storage components of a computing device, and are executed by a data processor(s) of the device.

Although described in connection with an example computing system environment, embodiments within the disclosure are operational with other special purpose computing system environments or configurations. The computing system environment is not intended to suggest any limitation as to the scope of use or functionality of any aspect of the disclosure. Moreover, the computing system environment should not be interpreted as having any dependency or requirement relating to any one or combination of components illustrated in the example operating environment. Examples of computing systems, environments, and/or configurations that may be suitable for use with aspects of the disclosure include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the aspects of the present disclosure may be described in the general context of data and/or processor-executable instructions, such as program modules, stored one or more tangible, non-transitory storage media and executed by one or more processors or other devices. Generally, program modules include, but are not limited to, routines, programs, objects, components, and data structures that perform particular tasks or implement particular abstract data types. Aspects of the present disclosure may also be practiced in distributed computing environments where tasks are performed by remote processing devices that are linked through a communications network. In a distributed computing environment, program modules may be located in both local and remote storage media including memory storage devices.

In operation, processors, computers and/or servers may execute the processor-executable instructions (e.g., software, firmware, and/or hardware) such as those illustrated herein to implement aspects of the disclosure.

Embodiments may be implemented with processor-executable instructions. The processor-executable instructions may be organized into one or more processor-executable components or modules on a tangible processor readable storage medium. Also, embodiments may be implemented with any number and organization of such components or modules. For example, aspects of the present disclosure are not limited to the specific processor-executable instructions, or the specific components or modules illustrated in the figures and described herein. Other embodiments may include different processor-executable instructions or components having more or less functionality than illustrated and described herein.

The order of execution or performance of the operations in accordance with aspects of the present disclosure illustrated and described herein is not essential, unless otherwise specified. That is, the operations may be performed in any order, unless otherwise specified, and embodiments may include additional or fewer operations than those disclosed herein. For example, it is contemplated that executing or performing a particular operation before, contemporaneously with, or after another operation is within the scope of the disclosure.

When introducing elements of the disclosure or embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Not all of the depicted components illustrated or described may be required. In addition, some implementations and embodiments may include additional components. Variations in the arrangement and type of the components may be made without departing from the spirit or scope of the claims as set forth herein. Additionally, different or fewer components may be provided and components may be combined. Alternatively, or in addition, a component may be implemented by several components.

The above description illustrates embodiments by way of example and not by way of limitation. This description enables one skilled in the art to make and use aspects of the disclosure, and describes several embodiments, adaptations, variations, alternatives, and uses of the aspects of the disclosure, including what is presently believed to be the best mode of carrying out the aspects of the embodiments. Additionally, it is to be understood that the aspects of the disclosure are not limited in its application to the details of construction and the arrangement of components set forth in the following description or illustrated in the drawings. The aspects of the disclosure are capable of other embodiments and of being practiced or carried out in various ways. Also, it will be understood that the phraseology and terminology used herein is for the purpose of description and should not be regarded as limiting.

It will be apparent that modifications and variations are possible without departing from the scope of the disclosure defined in the appended claims. As various changes could be made in the above constructions and methods without departing from the scope of the disclosure, it is intended that all matter contained in the above description and shown in the accompanying drawings shall be interpreted as illustrative and not in a limiting sense.

In view of the above, it will be seen that several advantages of the aspects of the disclosure are achieved and other advantageous results attained.

The Abstract and Summary are provided to help the reader quickly ascertain the nature of the technical disclosure. They are submitted with the understanding that they will not be used to interpret or limit the scope or meaning of the claims. The Summary is provided to introduce a selection of concepts in simplified form that are further described in the Detailed Description. The Summary is not intended to identify key features or essential features of the claimed subject matter, nor is it intended to be used as an aid in determining the claimed subject matter.

What is claimed is:

1. A method of securing a device configuration stored in memory associated with an industrial device, the method comprising:
receiving at the industrial device a write request from a user to write a new device configuration to the industrial device;
in response to the write request, requesting a certificate from the user;
receiving the certificate from the user, the certificate containing an identity of the user and a digital signature;
in response to receiving the certificate, evaluating the certificate to authenticate the user and determine the user has permission to write device configurations to the industrial device; and
after determining that the user has permission, writing the new device configuration to the memory and operating the industrial device in accordance with the new device configuration.

2. The method of claim 1, wherein said evaluating the certificate comprises sending the certificate from the industrial device to a certificate authority and receiving confirmation from the certificate authority that the certificate is valid.

3. The method of claim 1, wherein said evaluating the digital certificate comprises decrypting the certificate.

4. The method of claim 3, wherein the certificate is a self-signed certificate containing a public key, said decrypting comprising decrypting the digital signature with the public key.

5. The method of claim 3, wherein the certificate is a certificate authority-signed certificate containing for a certificate authority having a public key, said decrypting comprising decrypting the digital signature with the public key.

6. The method of claim 1, wherein said evaluating the certificate further comprises confirming that the certificate has a valid format.

7. The method of claim 1, wherein said evaluating the certificate comprises confirming that the certificate has all required content.

8. The method of claim 1, wherein said evaluating the certificate comprises confirming that the certificate can be decrypted.

9. The method of claim 1, wherein said evaluating the certificate comprises confirming the certificate is currently valid.

10. The method of claim 9, wherein said confirming the certificate is currently valid comprises confirming a current date is within a validity period contained in the certificate.

11. The method of claim 9, wherein said confirming the certificate is currently valid comprises querying a revocation list to confirm the certificate is not listed on the revocation list.

12. The method of claim 9, wherein said confirming the certificate is currently valid comprises querying an allowlist to confirm the certificate is listed on the allowlist.

13. The method of claim 1, wherein the industrial device is one of a programmable logic controller (PLC), a remote terminal unit (RTU), a distributed control system (DCS) controller, a multivariable transmitter (MVT), a sensor, and a human-machine interface (HMI).

14. An industrial device for an industrial automation system, the industrial device comprising:
a processor; and
a memory storing processor-executable instructions including a device configuration and a device configuration security module, the device configuration configuring the processor to operate in the industrial automation system in accordance with specified device capabilities, the device configuration security module configuring the processor to conduct a certificate-based authentication routine in response to receiving a request to write a new device configuration to the memory from the user.

15. The industrial device of claim 14, wherein the certificate-based authentication routine comprises
requesting a digital certificate from the user;
rejecting the new device configuration if the certificate from the user is not provided in response to said certificate request; and
conducting a certificate evaluation subroutine if the certificate is provided in response to said certificate request.

16. The industrial device of claim 15, wherein the certificate evaluation subroutine comprises:
sending the certificate provided by the user to a certificate authority for evaluation and receiving confirmation from the certificate authority whether the certificate is acceptable; or
locally evaluating data contained in the certificate to decrypt the certificate, confirm a format of the certificate is valid, and confirm the certificate is currently valid.

17. The industrial device of claim 16, wherein the certificate-based authentication routine further comprises:
rejecting the new device configuration if the certificate evaluation subroutine does not validate the certificate as acceptable; and
writing the new device configuration to the memory after the certificate evaluation subroutine validates the certificate as acceptable.

18. The industrial device of claim 17, wherein after writing the new device configuration to memory, the new device configuration configures the processor to operate in the industrial automation system in accordance with specified device capabilities defined by the new device configuration.

19. The industrial device of claim 14, the industrial device is one of a programmable logic controller (PLC), a remote terminal unit (RTU), a distributed control system (DCS) controller, a multivariable transmitter (MVT), a sensor, and a human-machine interface (HMI).

20. An industrial automation system comprising:
a plurality of industrial devices configured to operate the industrial automation system;
a computing device in communication with one of the industrial devices, the computing device comprising a memory storing a new device configuration for said one of the industrial devices and a certificate authenticating user authorization to change the configuration of the industrial device;
wherein said one of the industrial devices is configured to receive a request from the computing device to write the new device configuration to said one of the industrial devices, and in response, to conduct a certificate-based authentication routine by which said industrial device requests the digital certificate and evaluates the certificate to validate the certificate as acceptable and provide user authorization to change the configuration of the industrial device, before said one of the industrial devices applies the new device configuration in the industrial automation system.
